(19) United States
(12) Patent Application Publication
(10) Pub. No.: US 2026/0319840 A1
(43) Pub. Date: Oct. 15, 2026

(54) EVENT BASED LOAD BALANCED SCHEDULING

(71) Applicant: SAP SE, Walldorf (DE)

(72) Inventors: Tripti Malviya, Bangalore (IN); Harishankar Devaraj, Bangalore (IN)

(21) Appl. No.: 19/175,568

(22) Filed: Apr. 10, 2025

(51) Int. Cl. G06F 9/48; G06F 9/54

(52) U.S. Cl. CPC G06F 9/4887; G06F 9/546

(57) ABSTRACT

Embodiments of the present disclosure include techniques for event based load balanced scheduling. In one embodiment, an event based scheduling service receives a plurality of messages specifying a plurality of jobs. Each message comprises a time period specifying times at which each corresponding job is to be executed. For each message, the system (i) creates a first queue; (ii) creates a second queue; (iii) stores the message in the second queue; (iv) moves the message from the second queue to the first queue based on the corresponding time period for the message; and (v) sends the message to an interface application. The interface application invokes an execution application specified by the message to execute a job specified by the message.

### BACKGROUND

The present disclosure relates generally to computer software systems, and in particular, to systems and methods for event based load balanced scheduling.

Job scheduling is the process of planning and managing the execution of tasks or jobs to optimize system performance, resource usage, and time management. There are various solutions available for job scheduling. In some software applications, certain services such as the job scheduler service are used to create jobs. In Java, a framework called Spring offers scheduling capabilities for managing tasks. However, these solutions often encounter challenges, including uneven workload distribution, scaling limitations as more work comes in, and inadequate handling of redundancy and failover. Solutions that address these issues typically incorporate techniques like resource locking (e.g., database locks), to make sure jobs do not overlap or interfere with each other. Another solution is phased commit which breaks a job into smaller, sequential steps, ensuring that each step is completed successfully before moving on to the next, which helps prevent errors and allows for safer retries in case something goes wrong. While these approaches ensure jobs are done properly, they can negatively affect system performance and efficiency and even lead to the risk of deadlocks when two or more jobs get stuck waiting for each other to finish.

Therefore, job scheduling suffers from the technical challenge of ensuring efficient resource management, avoiding deadlocks, and/or maintaining scalability. The following disclosure provides various solutions to technical problems associated with such systems.

### BRIEF DESCRIPTION OF THE DRAWINGS

FIG. 1 illustrates a system for event based load balanced scheduling according to an embodiment.

FIG. 2 illustrates a method for event based load balanced scheduling according to an embodiment.

FIG. 3 illustrates an example flow of the system for event based load balanced scheduling according to an embodiment.

FIG. 4 illustrates an example flow of the system for event based load balanced scheduling according to an embodiment.

FIG. 5 illustrates hardware of a special purpose computing system configured according to the above disclosure.

### DETAILED DESCRIPTION

Described herein are techniques for load balanced scheduling. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

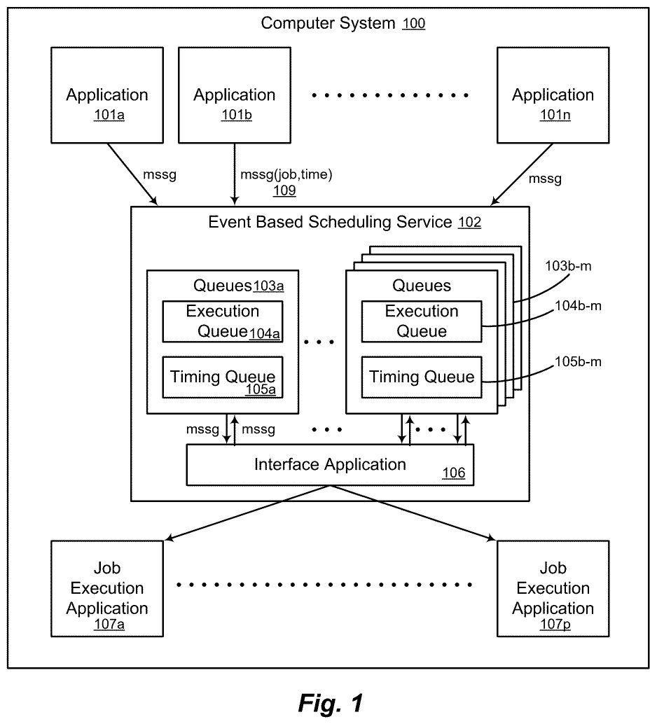

FIG. 1 illustrates a system for event based load balanced scheduling according to an embodiment. Features and advantages of the present disclosure include a plurality of applications 101a, 101b, 101n, an event based scheduling service 102 comprising a plurality of queues 103a, 103b-m, an interface application 106, and a plurality of job execution applications 107a-107p executing on a computer system 100. Computer system 100 may include, for example, one or more computers comprising one or more processors and a computer readable medium (memory) for executing software to perform the techniques described herein. Here, embodiments of the present disclosure include techniques for event based load balanced scheduling, for example. Embodiments of the present disclosure overcome the technical challenges associated with event based load balanced scheduling. Further examples for overcoming the technical challenges are described in more detail below.

Initially, the event based scheduling service 102 may receive multiple messages 109 that describe multiple jobs from various applications 101a-101n. Message 109 may include details about the job to be performed, along with a corresponding time period specifying when the job is to be executed. In some examples, the time period may be periodic (e.g., hourly, daily, weekly, or any other periodic time). The message may automatically initiate the creation of an execution queue 104a and a timing queue 105a in response to each message 109. In some embodiments, applications 101a-n may initiate creation of the execution queues and timing queues, and in other embodiments receipt of a message may cause event based scheduling service 102 to initiate creation of the execution queues and timing queues. In this example, the event based scheduling service 102 may create corresponding queues 103a-103m for each message. Each of these queues 103a-103m includes the execution queue 104a-104m and the timing queue 105a-105m, respectively. For one message 109, the event based scheduling service 102 may create its corresponding execution queue 104a and timing queue 105a. Once the execution queue 104a and timing queue 105a are created, the message 109 may be stored in the timing queue 105a. The message 109 moves from the timing queue 105a to the execution queue 104a when the time period to execute the job is reached (e.g., 5 pm each day). Upon receiving the message 109 in the execution queue 104a, queue 103a sends the message 109 to interface application 106. In some examples, the interface application 106 is scalable. However, in some example embodiments only one instance of the interface application 106 may execute the particular queue 103a at a given time. The interface application 106 may invoke one or more job execution applications 107a-107p, as specified by the message 109, to execute the job described in the message 109. After the job is executed, the queue 103a receives the message 109 from the interface application 106 and places it in the timing queue 105a. The process repeats by moving the message 109 from the timing queue 105a to the execution queue 104a when the time period to execute the job is reached, sending the message 109 to the interface application 106, invoking job execution applications 107a-107p to perform the job specified in the message 109, and receiving the message 109 back in the timing queue 105a. This may continue until the time period indicating the message 109 has expired is triggered, for example.

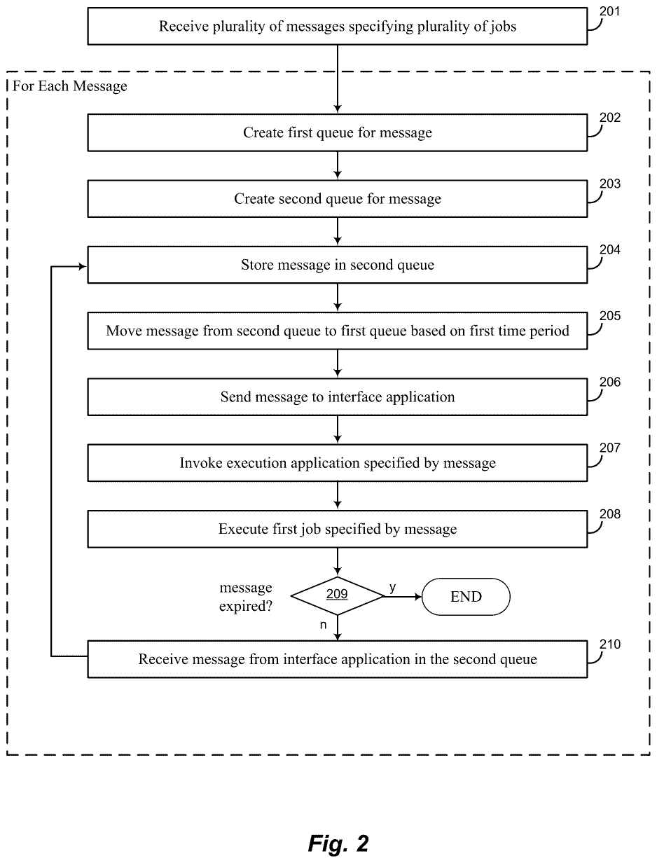

FIG. 2 illustrates a method for event based load balanced scheduling according to an embodiment. At 201, the event based scheduling service receives a plurality of messages specifying a plurality of jobs from a plurality of application. Each message comprises a time period specifying the times at which each corresponding job is to be executed. For each message of the plurality of messages, the following process is performed. At 202, a first queue is created for a message (e.g., the execution queue). At 203, a second queue is created for the message (e.g., the timing queue). At 204, the message is stored in the second queue. At 205, the event based scheduling service moves the message from the second queue to the first queue based on the corresponding time period for the first message (e.g., at a certain time each day). The message is deleted from the second queue on each occurrence of the time period. Upon receiving the message in the first queue, at 206, the first queue sends the message to an interface application. The message is deleted from the first queue when the first message is sent to the interface application. At 207, the interface application invokes an execution application specified by the message. At 208, the execution application executes a first job specified by the message. At 209, if the message has not expired, at 210, the second queue receives the message from the interface application and control returns to 204 where the process repeats. However, if the first message has expired at 209, the process ends.

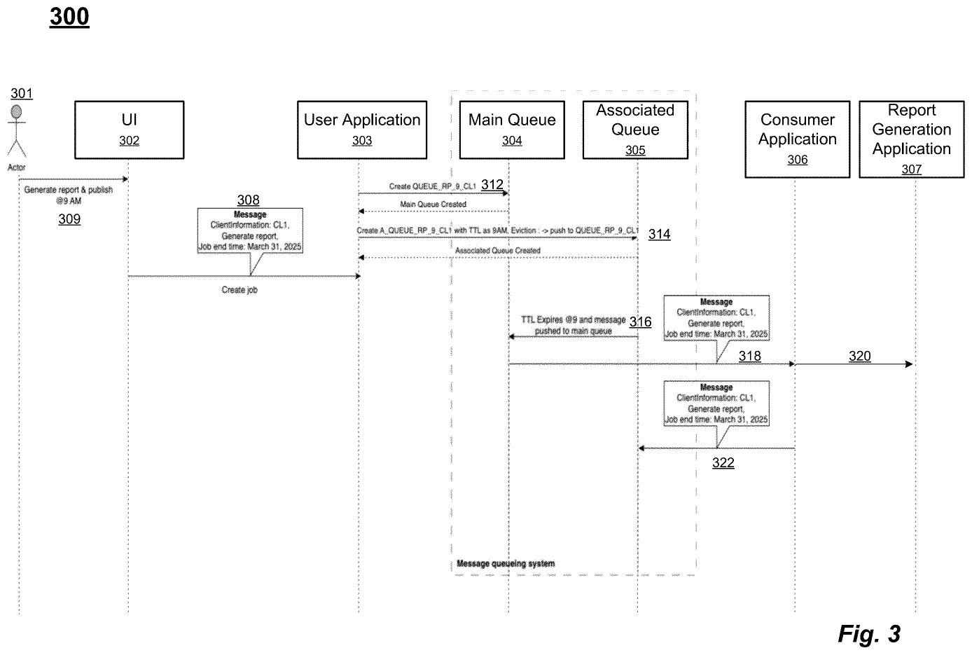

FIG. 3 illustrates an example flow of the system for event based load balanced scheduling according to an embodiment. In the illustrated example, a scheduling system 300 is used to address load balancing issues by employing a main queue (aka, execution queue) and an associated queue (aka, timing queue) with a time period. In this example, the time period is referred to as a time-to-live (TTL) parameter. In this example, user 301 (aka, actor) interacts with a user interface 302 of a user application 303 to create a message 308 that outlines a job to be carried out. At 308, a message that specifies a job of generating a report 309 (“Generate Report”) is created with a time specifying that the report is to be published at 9:00 a.m. (e.g., daily). The message may include client information (e.g., CL1), a job (aka a task) to be performed (e.g., generate report), and job end time (e.g., Mar. 31, 2025). At 312, the main queue 304, specified as QUEUE_RP_9_CL1, is created for the job to be executed. At 314, the associated queue 305, specified as A_QUEUE_RP_9_CL1 with time-to-live (TTL) parameter of 9:00 a.m. and an eviction process. The eviction process specifies that when a message in the associated queue 305 is deleted, it is moved to the main queue 304. The main queue 304 and the associated queue 305 are created once for each job at the time of job creation.

In this example, the TTL parameter is a user-defined TTL value that offer granular control over job prioritization, ensuring vital jobs are executed in a timely manner. The TTL parameter defines the maximum amount of time a job can stay in the queue before it is considered expired. TTL not only defines the maximum time a message or job can remain in the queue before being discarded but can also manage the timing between recurring job executions. TTL can control the interval between recurring jobs in a queue. For example, if the recurring task needs to be processed periodically (e.g., every hour or everyday), the TTL value can set the duration between each occurrence. In this example, the task needs to be processed every day at 9:00 a.m. Once the job is completed, the TTL ensures that the next job in the series is scheduled appropriately, preventing delays and backlog. When a job fails during processing, TTL ensures that it is not permanently discarded. Instead, the scheduling system 300 will keep the job in the queue for the specified TTL, and when the job is retried, it has another chance of success. This recycling of tasks through the main queue 304 after an error ensures jobs are not lost but rather queued for reprocessing. The provision of an error-handling mechanism prevents endless loops of unresolvable jobs, ensuring the main queue 304 and the associated queue 305 is not clogged with issues that could hinder overall operational efficiency. The scheduling system 300 automatically consumes the messages or jobs in the queue that are ready to be processed based on their TTL, which helps in handling jobs efficiently. Together, the main queue 304 and the associated queue 305 with the TTL parameter create a more precise, automated and efficient job scheduling system.

At 316, once the TTL is reached, the associated queue 305 will deliver the message 308 to the main queue 304. At 318, the main queue 304 processes the message 308 and delivers the message 308 to an interface application 306, referred to here as a “consumer application” (e.g., which consumes jobs). At 320, the consumer application 306 invokes a report generation application 307 to execute the job specified in the message. At 322, the consumer application 306 sends the message 308 back to the associated queue 305. The process at the associated queue repeats until the message 308 expires, as specified by the “Job End Time” in the message. The scheduling system 300 improves job scheduling by automatically rerouting and reprocessing messages, reducing the need for manual intervention and improving overall scheduling system 300 efficiency.

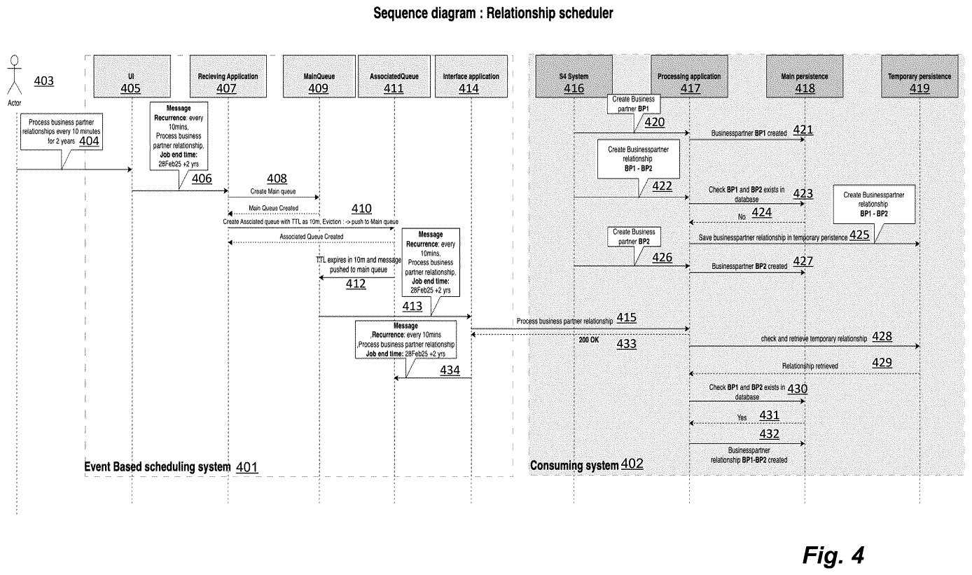

FIG. 4 illustrates an example system flow 400 of an event based scheduling system according to an embodiment. In the illustrated example, the event based scheduling system 401 interacts with a consuming system 402 (e.g., which consumes jobs) to execute a job of creating business partner relationships. In this example, user 403 (aka, actor) submits a job 404 or a task through a user interface (UI) 405. The job 404 specifies a task to “process business partner relationships” with a time specifying that the job is to be processed every 10 minutes (e.g., defined intervals) for 2 years (e.g., job execution duration in relation to the job's start time). The UI 405 sends a message 406 containing the job details to a receiving application 407 (aka, user application).

The message 406 outlines the job to be carried out. The message 406 may include a predefined interval for sending the particular message (e.g., message recurrence) to perform a job (aka, a task) and job end time (e.g., 28 Feb. 2025+2 years). At 408, a main queue 409 (aka, execution queue) is created for the job to be executed. At 410, an associated queue 411 (aka, timing queue) is created with a time period (e.g., TTL parameter) of 10 minutes and an eviction process. The eviction process specifies that when a message in the associated queue 411 is deleted, it is moved to the main queue.

At 412, once the TTL is reached, the associated queue 411 will deliver the message 406 to the main queue 409. At 413, the main queue 409 processes the message 406 and delivers the message 406 to an interface application 414. At 415, the interface application 414 invokes a consuming system 402 to execute the job of processing business partner relationship, as specified in the message 406. Specifically, the message 406 is sent to a processing application 417 in the consuming system 402.

The consuming system 402 comprises of a S4 system 416 (e.g., S/4HANA system, an enterprise resource planning (ERP) software), a processing application 417, a main persistence database 418 and a temporary persistence layer 419. Before the consuming system 402 receive the job to “process business partner relationship” from the event based scheduling system 401, the S4 system 416 first creates and sets up a business partner BP1 and BP2. The S4 system 416 initiates a request to create a business partner BP1. The request might originate from a user action within the S4 system 416 interface or through an automated process. At 420, the S4 system 416 sends a detailed message or data payload to the processing application 417, containing the necessary information for creating BP1. Upon receiving the request, at 421 the processing application 417 communicates with the main persistence database 418 to create a new entry in the main persistence database 418 for business partner BP1. The S4 system 416 triggers a process to create a business partner relationship between BP1 and BP2. This can be initiated via a user interface action or an automated scheduled job. At 422, the S4 system 416 constructs a message to “create business partner relationship between BP1 and BP2” and sends this message to the processing application 417 to request the creation of the relationship. At 423, the processing application 417 queries the main persistence database 418 to check if both BP1 and BP2 exist in the database 418. At 424, if the processing application 417 discovers that either BP1 or BP2 does not exist in the main persistence database 418, at 425, the processing application 417 creates a temporary record of the intended business partner relationship in the temporary persistence layer 419. The S4 system 416 is notified about the issue. At 426, the S4 system 416 sends a message to “create business partner BP2” to the processing application 417. Upon receiving the request, at 427, the processing application 417 communicates with the main persistence database 418 to create a new entry in the main persistence database 418 for business partner BP2.

After the business partner BP1 and BP2 is created, the consuming system 402 may receive and process the “process business partner relationship” message from the event based scheduling system 401. At 415, the processing application 417 receives the message 406 to “process business partner relationship” that indicates that a pending relationship between BP1 and BP2 is to be created. At 433, the processing application 417 constructs a confirmation response “200 OK”, a hypertext transfer protocol (HTTP) status code indicating that the request made by the event based scheduling system 401 was received by the consuming system 402. At 428, the processing application 417 checks its temporary persistence layer 419 to retrieve any temporary relationship data for BP1 and BP2. If the relationship is found in the temporary persistence layer 419, at 429, the processing application 417 retrieves the relationship details required to process the relationship creation request. At 430, the processing application 417 queries the main persistence database 418 to determine if both BP1 and BP2 exist. At 431, if both BP1 and BP2 exist, the processing application 417 continues to create a business partner relationship. At 432, the processing application 417 inserts the new relationship in the main persistence database 418 and the job to process business partner relationship is completed.

The interface application 414 receives the successful job completion status from the processing application 417. At 434, the interface application 414 sends the message 406 back to the associated queue 411. The process at the associated queue 411 repeats until the message 406 expires, as specified by the “Job End Time” in the message. The event based scheduling system 401 improves job scheduling by automatically rerouting and reprocessing messages, reducing the need for manual intervention and improving overall scheduling system 401 efficiency.

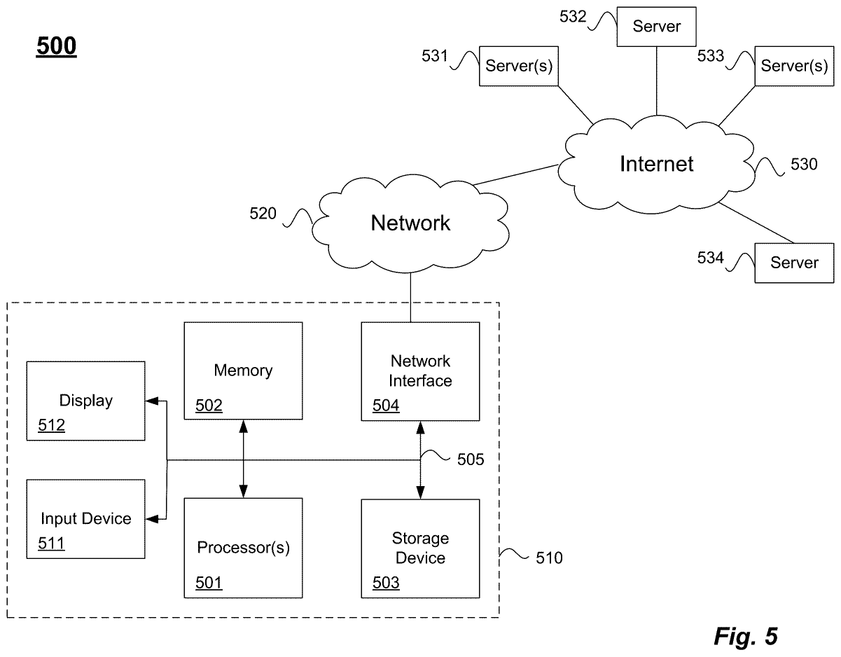

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### FURTHER EXAMPLES

Each of the following non-limiting features in the following examples may stand on its own or may be combined in various permutations or combinations with one or more of the other features in the examples below. In various embodiments, the present disclosure may be implemented as a system, method, or computer readable medium.

Embodiments of the present disclosure may include systems, methods, or computer readable media. In one embodiment, the present disclosure includes computer system comprising: at least one processor and at least one non-transitory computer readable medium (e.g., memory) storing computer executable instructions that, when executed by the at least one processor, cause the computer system to perform methods as described herein and in the following examples. In another embodiment, the present disclosure includes a non-transitory computer-readable medium storing computer-executable instructions that, when executed by at least one processor, perform the methods as described herein and in the following examples.

In one embodiment, the present disclosure includes a computer implemented method comprising: receiving, from a plurality of applications, a plurality of messages specifying a plurality of jobs, wherein each message comprises a time period specifying times at which each corresponding job is to be executed; for each message of the plurality of messages: (i) creating a first queue for a first message; (ii) creating a second queue for the first message; (iii) storing the first message in the second queue; (iv) moving the first message from the second queue to the first queue based on the corresponding time period for the first message; (v) upon receiving the first message in the first queue, sending the first message to an interface application, the interface application invoking an execution application specified by the first message to execute a first job specified by the first message; (vi) receiving the first message from the interface application in the second queue; and repeating steps (iv) to (vi) until expiration of the first message.

In one embodiment, the expiration of the first message is specified by a second time in the first message.

In one embodiment, the steps (i) and (ii) are initiated by the plurality of applications (API).

In one embodiment, the steps (i) and (ii) are initiated automatically in response to each message.

In one embodiment, the plurality of messages are received in a queue service, the queue service creating one first queue and one second queue for each message.

In one embodiment, the first message is deleted from the second queue on each occurrence of the time period.

In one embodiment, the first message is deleted from the first queue when the first message is sent to the interface application.

In one embodiment, the time period is periodic.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A computer implemented method comprising:
receiving, from a plurality of applications, a plurality of messages specifying a plurality of jobs, wherein each message comprises a time period specifying times at which each corresponding job is to be executed;
for each message of the plurality of messages:
(i) creating a first queue for a first message;
(ii) creating a second queue for the first message;
(iii) storing the first message in the second queue;
(iv) moving the first message from the second queue to the first queue based on the corresponding time period for the first message;
(v) upon receiving the first message in the first queue, sending the first message to an interface application, the interface application invoking an execution application specified by the first message to execute a first job specified by the first message;
(vi) receiving the first message from the interface application in the second queue; and
(vii) repeating steps (iv) to (vi) until expiration of the first message.

2. The method of claim 1, wherein the expiration of the first message is specified by a second time in the first message.

3. The method of claim 1, wherein steps (i) and (ii) are initiated by the plurality of applications.

4. The method of claim 1, wherein steps (i) and (ii) are initiated automatically by a service in response to each message.

5. The method of claim 1, wherein the plurality of messages are received in an event based scheduling service, the event based scheduling service creating one first queue and one second queue for each message.

6. The method of claim 1, wherein the first message is deleted from the second queue on each occurrence of the time period.

7. The method of claim 1, wherein the first message is deleted from the first queue when the first message is sent to the interface application.

8. The method of claim 1, wherein the time period is periodic.

2. A computer system comprising:
at least one processor;
at least one non-transitory computer-readable medium storing computer-executable instructions that, when executed by the at least one processor, cause the computer system to execute a method comprising:
receiving, from a plurality of applications, a plurality of messages specifying a plurality of jobs, wherein each message comprises a time period specifying times at which each corresponding job is to be executed;
for each message of the plurality of messages:
(i) creating a first queue for a first message;
(ii) creating a second queue for the first message;
(iii) storing the first message in the second queue;
(iv) moving the first message from the second queue to the first queue based on the corresponding time period for the first message;
(v) upon receiving the first message in the first queue, sending the first message to an interface application, the interface application invoking an execution application specified by the first message to execute a first job specified by the first message;
(vi) receiving the first message from the interface application in the second queue; and
(vii) repeating steps (iv) to (vi) until expiration of the first message.

10. The computer system of claim 9, wherein the expiration of the first message is specified by a second time in the first message.

11. The computer system of claim 9, wherein steps (i) and (ii) are initiated by the plurality of applications.

12. The computer system of claim 9, wherein steps (i) and (ii) are initiated automatically by a service in response to each message.

13. The computer system of claim 9, wherein the plurality of messages are received in an event based scheduling service, the event based scheduling service creating one first queue and one second queue for each message.

14. The computer system of claim 9, wherein the first message is deleted from the second queue on each occurrence of the time period.

3. A non-transitory computer-readable medium storing computer-executable instructions that, when executed by at least one processor of a computer system, cause the computer system to execute method comprising:
receiving, from a plurality of applications, a plurality of messages specifying a plurality of jobs, wherein each message comprises a time period specifying times at which each corresponding job is to be executed;
for each message of the plurality of messages:
(i) creating a first queue for a first message;
(ii) creating a second queue for the first message;
(iii) storing the first message in the second queue;
(iv) moving the first message from the second queue to the first queue based on the corresponding time period for the first message;
(v) upon receiving the first message in the first queue, sending the first message to an interface application, the interface application invoking an execution application specified by the first message to execute a first job specified by the first message;
(vi) receiving the first message from the interface application in the second queue; and
(vii) repeating steps (iv) to (vi) until expiration of the first message.

16. The non-transitory computer-readable medium of claim 15, wherein the expiration of the first message is specified by a second time in the first message.

17. The non-transitory computer-readable medium of claim 15, wherein steps (i) and (ii) are initiated by the plurality of applications.

18. The non-transitory computer-readable medium of claim 15, wherein steps (i) and (ii) are initiated automatically by a service in response to each message.

19. The non-transitory computer-readable medium of claim 15, wherein the plurality of messages are received in an event based scheduling service, the event based scheduling service creating one first queue and one second queue for each message.

20. The non-transitory computer-readable medium of claim 15, wherein the first message is deleted from the first queue when the first message is sent to the interface application.
